(19) United States
(12) Patent Application Publication
(10) Pub. No.: US 2024/0367388 A1
(43) Pub. Date: Nov. 7, 2024

(54) HIGH-FREQUENCY WELDING APPARATUS FOR BONDING CORNER OF AIR MATTRESS

(71) Applicant: ANSSIL CO., LTD., Gwangju-si (KR)

(72) Inventor: Beom Keun SONG, Suwon-si (KR)

(73) Assignee: ANSSIL CO., LTD., Gwangju-si (KR)

(21) Appl. No.: 18/440,973

(22) Filed: Feb. 14, 2024

(30) Foreign Application Priority Data
May 3, 2023 (KR) 10-2023-0057499

(51) Int. Cl. B29C 65/04; B29L 31/00

(52) U.S. Cl. CPC B29C 65/04; B29L 2031/751

(57) ABSTRACT

Disclosed is a high-frequency welding apparatus for bonding a corner of an air mattress. The high-frequency welding apparatus includes a housing, an electrode plate disposed at one side of the housing such that a positive power supply is connected to the electrode plate, and configured to move in a horizontal direction so as to press shape maintenance member surrounding the corner, a surface plate disposed to collinearly face the electrode the shape maintenance member interposed plate with therebetween, and configured to support the pressed shape maintenance member, and an electrode pushing block and a surface plate pushing block formed of a metal and fixed to front ends of the electrode plate and the surface plate to apply high-frequency pressure to the shape maintenance member and to guide a melt to be injected into a space between the edges of the upper part and the lower part.

### BACKGROUND OF THE INVENTION

### Field of the Invention

The present invention relates to a high-frequency welding apparatus, particularly, to a high-frequency welding apparatus for bonding a corner of an air mattress which bonds each of corners of a mattress main body, including an upper part and a lower part cut to fit a specific size of the air mattress, by welding.

### Description of the Related Art

In general, a bed includes a bed frame and a mattress placed on the upper surface of the bed frame to support a user.

Mattresses having a plurality of springs installed therein or formed of a material with cushioning power, such as latex foam, are generally used to support the user's load with the cushioning power, and in addition, mattresses having a structure into which water or air is injected are also widely used.

Thereamong, an air mattress into which air is injected has the advantages of being light in weight and being capable of adjusting cushioning strength and height because the amount of air injected thereinto may be adjusted.

Recently, a string-type air mattress in which an upper part and a lower part are connected by a plurality of strings has been developed, and such a string-type air mattress has not only cushioning power caused by air filling the inside of the air mattress but also elastic force caused by the strings provided in the air mattress and thus has the advantages of being light in weight and having enhanced cushioning power.

Korean Patent Registration No. 10-1980575 (May 21, 2019) discloses technology related to a string-type air mattress entitled “Method of manufacturing air mattress and air mattress manufactured thereby”.

In the above technology, a sealing tape is adhered to the entirety of the edges of lower fabric and upper fabric interlocked with each other, half of the longitudinal width of the sealing tape is adhered to the lower fabric and the other half is adhered to the upper fabric, and shape maintenance members are respectively adhered to the corners of the air mattress.

However, since the shape maintenance members to which an adhesive, such as an oil-based adhesive, is applied are placed at the corners and are then adhered to the corners by heat and pressure, the shape maintenance members are detached from adhesive areas of the corners due to deterioration of the adhesive strength of the adhesive over a designated period of time, and the reason for this is that, because the air mattress includes a plastic material component on the surface thereof, the adhesive strength of the adhesive inevitably deteriorates as the plastic material pushes out the adhesive through a reverse reaction with the adhesive as a designated time passes by.

In addition, as the process of adhering the shape maintenance members to the corners of the mattress depends entirely on proficiency of a worker, there are limits in ensuring uniformity in adhesion of of the shape maintenance members to the corners, and above all, because the process is performed while checking the adhesion positions one by one, there is a problem that a time taken to complete the adhesion process is inevitably increased.

### RELATED ART DOCUMENTS

### Patent Documents

Patent Document 1: Korean Patent Registration No. 10-1980575 (Registration Date: May 21, 2019)

### SUMMARY OF THE INVENTION

Therefore, the present invention has been made in view of the above problems, and it is an object of the present invention to provide a high-frequency welding apparatus for bonding a corner of an air mattress which may melt and integrate only a shape maintenance member and upper and lower parts through high-frequency heating, when bonding the corner of the air mattress using the shape maintenance member, so as to increase adhesive strength at the corner without using an adhesive.

In accordance with the present invention, the above and other objects can be accomplished by the provision of a high-frequency welding apparatus for bonding a corner of an air mattress configured to adhere a shape maintenance member to each corner of the air mattress in which a sealing tape is adhered to edges of an upper part and a lower part configured to face each other, the high-frequency welding apparatus including a housing equipped with a high-frequency oscillator installed therein, an electrode plate disposed at one side of the housing such that a positive power supply is connected to the electrode plate, and configured to move in a horizontal direction so as to press the shape maintenance member configured to surround the corner of the air mattress, a surface plate disposed to collinearly face the electrode plate with the shape maintenance member interposed therebetween, and configured to support the pressed shape maintenance member, and an electrode pushing block and a surface plate pushing block formed of a metal and fixed to front ends of the electrode plate and the surface plate, respectively, to apply high-frequency pressure to the shape maintenance member and to guide a melt of the shape maintenance member, the upper part and the lower part to be injected into a space between the edges of the upper part and the lower part adhered to the sealing tape.

A plurality of pushing protrusions and a plurality of guide inflow grooves may be alternately formed at corresponding surfaces positions on facing of the electrode pushing block and the surface plate pushing block, the pushing protrusions may come into first contact with the shape maintenance member and press contact areas during high-frequency pressing so that the melt of the shape maintenance member, the upper part and the lower part flows into the guide inflow grooves at sides of the pushing protrusions, and the guide inflow grooves may guide the melt to be injected into the space formed between the edges of the upper part and the lower part.

The pushing protrusions may protrude farther than the corresponding surfaces of the electrode pushing block and the surface plate pushing block.

A pair of stoppers configured to control a moving distance of the electrode plate may protrude from both sides of the electrode plate and the surface plate or both sides of any one of the electrode plate and the surface plate.

A leveling member configured to maintain leveling of the shape maintenance member configured to surround the corner of the air mattress disposed between the electrode plate and the surface plate may be further provided on an upper surface of the surface plate pushing block.

A movement control device provided such that the electrode plate is installed thereon to be movable and configured to control a moving distance of the electrode plate may be provided between the electrode plate and the housing.

A current amount control knob configured to control an amount of current applied to the electrode plate may be provided on the housing.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view showing an air mattress in which corners are bonded by a high-frequency welding apparatus according to the present invention;

FIG. 2 is a perspective view of the corner of the air mattress showing the state of the corner before bonding;

FIGS. 3 and 4 are perspective and side views showing the high-frequency welding apparatus according to the present invention;

FIGS. 5 and 6 are perspective and plan views showing the structure of a main part of the high-frequency welding apparatus according to the present invention;

FIGS. 7(a) to 7(c) are cross-sectional views taken along line I-I of FIG. 6, showing a process of adhering a shape maintenance member to the corner of the air mattress by the high-frequency welding apparatus according to the present invention; and

FIGS. 8(a) to 8(c) are cross-sectional views taken along line II-II of FIGS. 7(a) to 7(c).

### DETAILED DESCRIPTION OF THE INVENTION

Hereinafter, reference will be made in detail to various embodiments of the present invention, examples of which are illustrated in the accompanying drawings and described below. However, the present invention is not limited to the embodiments disclosed herein and may be implemented in various different forms. The embodiments are provided to make the description of the present invention thorough and to fully convey the scope of the present invention to those skilled in the art. Therefore, shapes and dimensions of elements in the accompanying drawings may be exaggerated compared to the actual shapes and dimensions thereof, for clarity of description.

In the following description of the embodiments, terms, such as “first” and “second”, may be used to describe various elements but do not limit the elements. These terms are used only to distinguish one element from other elements.

The terminology used herein is for the purpose of describing particular exemplary embodiments only and is not intended to be limiting. Singular expressions may encompass plural expressions, unless they have clearly different contextual meanings. In the following description of the embodiments, terms, such as “including”, “comprising” and “having”, are to be interpreted as indicating the presence of characteristics, numbers, steps, operations, elements or parts stated in the description or combinations thereof, and do not exclude in advance the presence of one or more other characteristics, numbers, steps, operations, elements, parts or combinations thereof, or the possibility of adding the same.

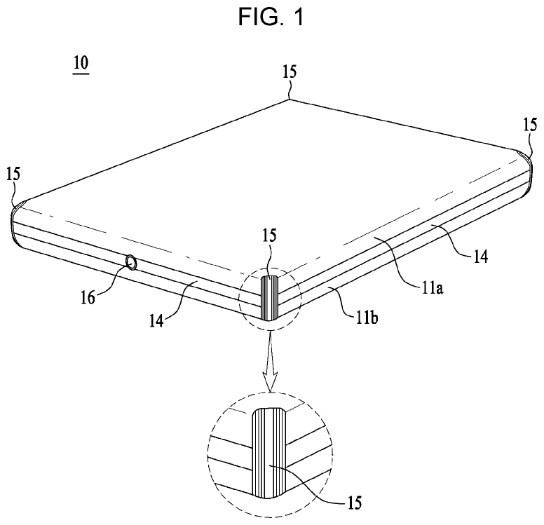

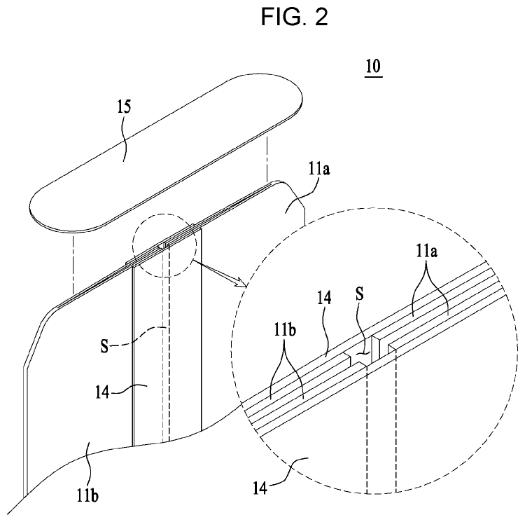

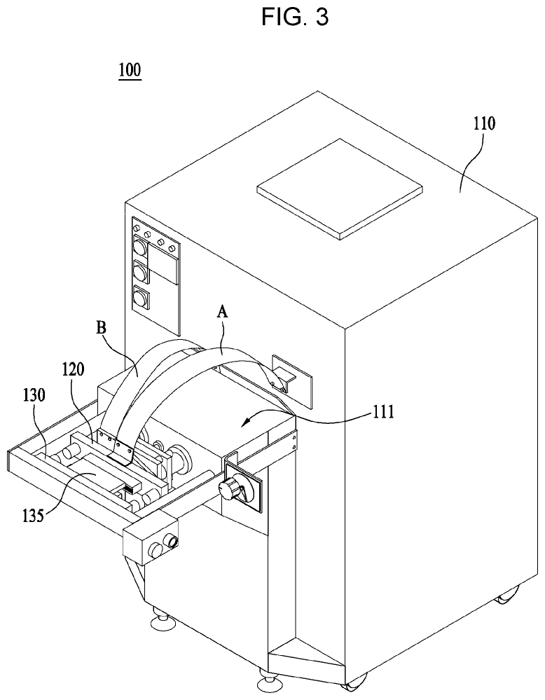

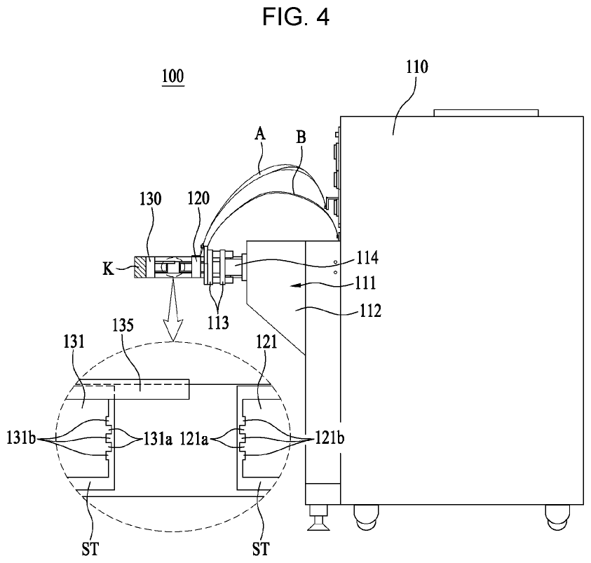

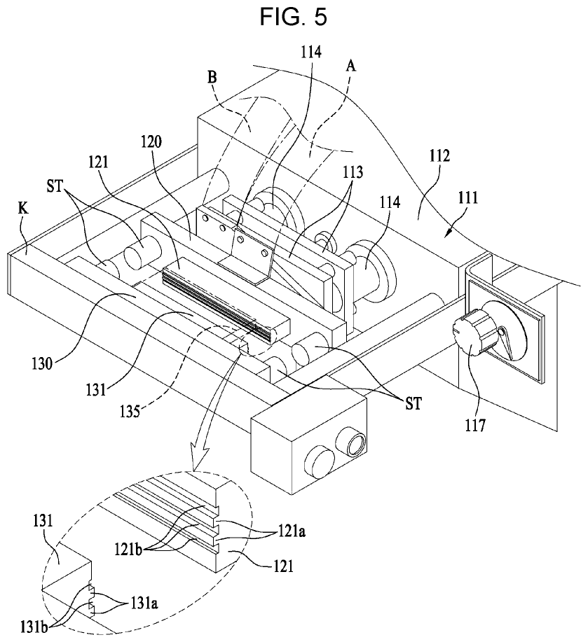

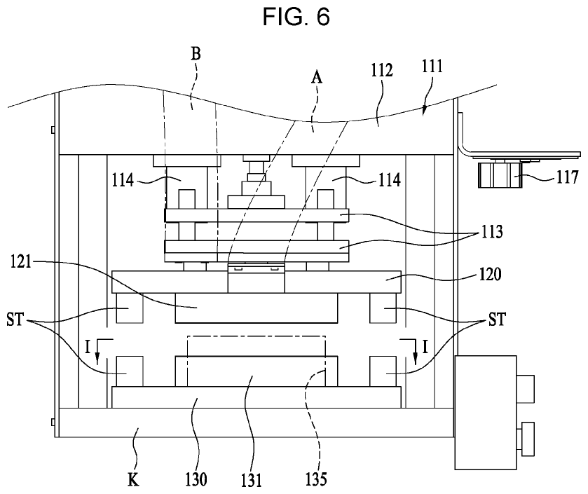

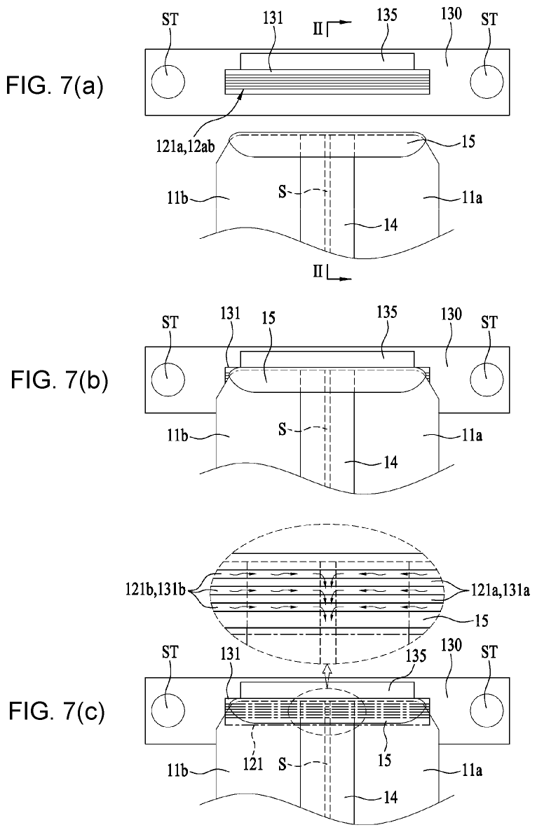

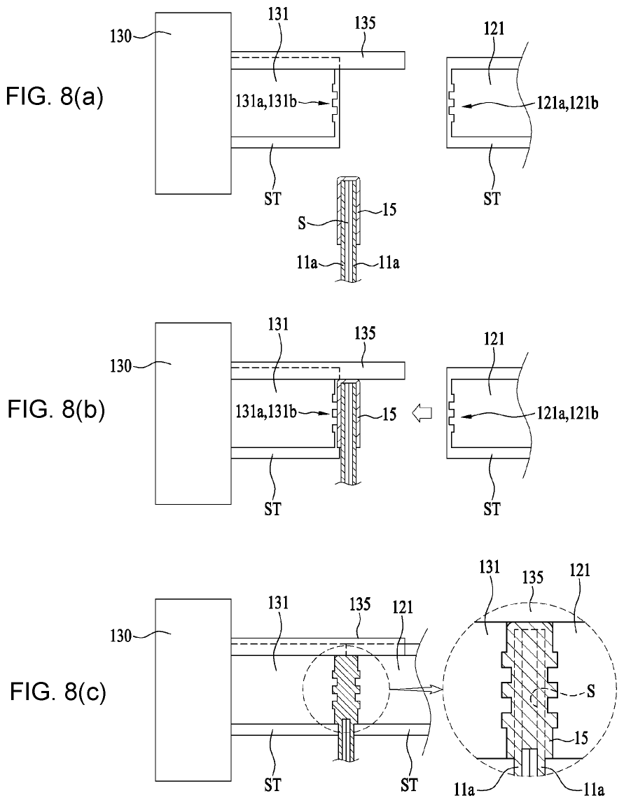

FIG. 1 is a perspective view showing an air mattress in which corners are bonded by a high-frequency welding apparatus according to the present invention, FIG. 2 is a perspective view of the corner of the air mattress showing the state of the corner before bonding, FIGS. 3 and 4 are perspective and side views showing the high-frequency welding apparatus according to the present invention, FIGS. 5 and 6 are perspective and plan views showing the structure of a main part of the high-frequency welding apparatus according to the present invention, FIGS. 7(a) to 7(c) are cross-sectional views taken along line I-I of FIG. 6, showing a process of adhering a shape maintenance member to the corner of the air mattress by the high-frequency welding apparatus according to the present invention, and FIGS. 8(a) to 8(c) are cross-sectional views taken along line II-II of FIGS. 7(a) to 7(c).

As shown in FIGS. 1 to 8(c), a high-frequency welding apparatus 100 according to the present invention includes a housing 110 equipped with a high-frequency oscillator installed therein, an electrode plate 120 disposed at one side of the housing 110 such that a positive power supply A is connected to the electrode plate 120, and configured to move in the horizontal direction so as to press a shape maintenance member 15 surrounding a corner of an air mattress 10, a surface plate 130 disposed to collinearly face the electrode plate 120 with the shape maintenance member 15 interposed therebetween, and configured to support the pressed shape maintenance member 15, and an electrode pushing block 121 and a surface plate pushing block 131 formed of a metal and fixed to front ends of the electrode plate 120 and the surface plate 130, respectively, to apply high-frequency pressure to the shape maintenance member 15 and to guide the melt of the shape maintenance member 15, an upper part 11a and a lower part 11b to be injected into a space S between the edges of the upper part 11a and the lower part 11b adhered to a sealing tape 14.

Prior to explanation, the high-frequency welding apparatus 100 according to the present invention allows only the shape maintenance member 15, the upper part 11a and the lower part 11b to be melted and fused to increase adhesiveness, and does not require a high degree of proficiency to adhere the shape maintenance member 15 to the corner of the air mattress 10, that was conventionally required, when the shape maintenance member 15 is adhered to the corner of the air mattress 10 through high-frequency heating.

In addition, respective structures, which will be described below, are controlled by a separate controller (not shown).

The high-frequency welding apparatus 100 according to the present invention may include the housing 110, the electrode plate 120, the surface plate 130, the electrode pushing block 121, and the surface plate pushing block 131.

FIG. 1 shows four corners of the air mattress 10 that are bonded by the high-frequency welding apparatus 100 according to the present invention.

The air mattress 100, the corners of which are bonded by the high-frequency welding apparatus 100, includes the upper part 11a and the lower part 11b cut to fit a size, such as king size, queen size, or super single size, the sealing tape 14 adhered to the four side surfaces of the upper part 11a and the lower part 11b along the peripheries thereof so as to seal the edges of the upper part 11a and the lower part 11b in the state in which the edges of the upper part 11a and the lower part 11b face each other, the shape maintenance members 15 configured to bond the corners of the upper part 11a and the lower part 11b, the edges of which are sealed by the sealing tape 14, and an air injection valve 16 configured to inject air into the air mattress 10, sealing of which has been completed.

The shape maintenance member 15 is adhered to each of the corners of the air mattress 10, in which the upper part 11a and the lower part 11b are sealed by the sealing tape 14 through a pre-bonding process, by the high-frequency welding apparatus 100, and the shape maintenance member 15 is placed at the distal end of the corner of the air mattress 10, in which two side surfaces of the air mattress 10 meet, and is bent to both sides from the distal end of the corner based on the longitudinal center of the air mattress 10, as shown in FIG. 2 (with reference to FIGS. 7(a) to 7(c) and 8(a) to 8(c)).

Of course, bonding of the corners through the shape maintenance members 15 is performed after the upper part 11a and the lower part 11b of the air mattress 10 have already been sealed by the sealing tape 14.

The air mattress 10 takes the shape of a hexahedron, as shown in FIG. 1, through final bonding of the shape maintenance member 15 to the air mattress 10.

In addition, the material of the shape maintenance members 15 may be the same as the material of the upper part 11a, the lower part 11b and the sealing tape 14, i.e., PVC, PE, PP, or the like, and the reason for this is that melting of the same material may occur most ideally during heat fusion using high frequency.

The air mattress 10 manufactured by the high-frequency welding apparatus 100 according to the present invention may include the upper part 11a, the lower part 11b, and a plurality of strings (not shown) provided therein. However, the present invention is technically characterized in that the shape maintenance member 15 is melted and adhered to each of the corners of the air mattress 10 with the sealing tape 14 adhered thereto, and the air mattress 10 may only be filled with air without a plurality of strings.

Further, the shape maintenance member 15 adhered to each of the corners of the air mattress 10 is fused to the upper part 11a and the lower part 11b in the process of welding the shape maintenance member 15 to each corner through high frequency, and thus serves as a pillar on the outermost side of each corner, thereby allowing the corresponding corner to withstand a set load.

That is, when an instantaneous load is applied to the corner of the air mattress 10, a safety incident occurring due to collapse of the corner may be prevented.

Particularly, because, when the air mattress 10 is applied to a bed, standards for a load applied the corners of the air mattress 10 are strictly proposed, the shape maintenance members 15 are welded to the corners of the air mattress 10 so that the corners are angled, thereby enabling the corners of the air mattress 10 to withstand the set load without collapsing.

The housing 110 may be implemented in a predetermined hexahedral shape, as shown in FIGS. 3 and 4, and the high-frequency oscillator (not shown) configured to oscillate high-frequency current to the electrode plate 120 and the surface plate 130, which will be described later, is installed in the housing 110.

Here, the high-frequency oscillator is a device that generates high-frequency current, and the high-frequency oscillator is widely used throughout the industry and a detailed description thereof will thus be omitted.

Further, a current amount control knob 117 that controls the amount of current applied to the electrode plate 120, which will be described later, may be provided on the housing 110.

The current amount control knob 117 serves to adjust the amount of current applied to the electrode plate 120 so as to match the thickness or adhesive strength of the shape maintenance member 15 which is a target to be adhered.

The electrode plate 120 is formed of a conductive material through which current may flow well, and is disposed at one side of the housing 110 such that the positive power supply A is connected to the electrode plate 120 so as to supply positive current to the electrode plate 120 from the housing 110, as shown in FIGS. 4 to 6.

The electrode plate 120 maintains a rectangular shape having a designated length, and is installed to be movable in the horizontal direction.

Movement of the electrode plate 120 is performed to press one surface of the shape maintenance member 15 surrounding the corner during high-frequency heating so as to bond the corner of the air mattress 10 between the surface plate 130 and the electrode plate 120 which will be described later (with reference to FIG. 8(c)).

Further, a movement control device 111 provided such that the electrode plate 120 is installed thereon to be movable in the horizontal direction and configured to control the moving distance of the electrode plate 120 may be provided between the electrode plate 120 and the housing 110.

That is, the movement control device 111 controls movement of the electrode plate 120 so that the shape maintenance member 15 may be melted through high-frequency heating under optimum pressure.

The movement control device 111 includes a drive box 112 configured such that a driver (not shown) (or a cylinder or a driving motor) controlled by the controller is installed therein, and a plurality of moving rods 114 having a rod shape extending from the drive box 111 and connected to moving panels 113 disposed behind the electrode plate 120.

In addition, elastic members (not shown) configured to buffer pressing force during pressing for high-frequency adhesion may be provided between the moving panels 113 and the electrode plate 120.

Further, a negative power supply B, which is connected to negative current from the housing 110 and is grounded to the earth, is connected to the moving panels 113.

That is, the movement control device 111 moves the electrode plate 120 by a set distance together with the moving panels 113 depending on forward and backward movement of the moving rods 140 by driving the drive box 112.

The surface plate 130 is formed of a conductive material through which current may flow well, and disposed to collinearly face the electrode plate 120 by a separate fixing bracket K from the housing 110 of the high-frequency welding apparatus 100 which uses a negative terminal as a ground.

The surface plate 130 has a shape corresponding to the electrode plate 120, and the surface plate 130 supports the other surface of the pressed shape maintenance member 15 surrounding the corner of the air mattress 10 disposed between the electrode plate 120 and the surface plate 130, when the shape maintenance member 15 is pressed by the electrode plate 120.

That is, the surface plate 130 supports the other surface of the shape maintenance member 15, and thereby, the other surface of the shape maintenance member 15 may be pressed at the same time (with reference to FIG. 8(c)).

The electrode pushing block 121 and the surface plate pushing block 131 are formed of a metal through which current flows smoothly, and are fixed to opposite front ends of the electrode pushing block 121 and the surface plate pushing block 131 facing each other to apply pressure one surface and the other surface of the shape maintenance member 15 surrounding the corner of the air mattress 10 disposed between the electrode plate 120 and the surface plate 130 through high frequency.

That is, the electrode pushing block 121 and the surface plate pushing block 131 press the shape maintenance member 15 in the state in which current from the electrode plate 120 and the surface plate 130 flows to the electrode pushing block 121 and the surface plate pushing block 131, respectively.

Here, the electrode pushing block 121 and the surface plate pushing block 131 maintain a designated width and length, and are installed at positions corresponding to each other on the electrode plate 120 and the surface plate 130, so as to enable pushing protrusions 121a and 131a and guide inflow grooves 121b and 131b formed on the electrode pushing block 121 and the surface plate pushing block 131, which will be described later, to coincide with each other when pressed.

In addition, when the electrode pushing block 121 and the surface plate pushing block 131 guide the melt of the shape maintenance member 15, the upper part 11a and the lower part 11b to be injected into the space S between the edges of the upper part 11a and the lower part 11b adhered to the sealing tape 14, as shown in FIG. 2, when the shape maintenance member 15 is heated under high-frequency pressure.

That is, by guiding the melt to fill the space S, the upper part 11a and the lower part located at the corner, where the shape maintenance member 15 is adhered, and the shape maintenance member 15 may be integrated into a single body. Specifically, this serves to maximize the sealed state of the corner.

For this purpose, a plurality of pushing protrusions 121a and 131a and a plurality of guide inflow grooves 121b and 131b may be alternately formed at corresponding positions on facing surfaces of the electrode pushing block 121 and the surface plate pushing block 131, as shown in FIGS. 4 and 5.

Here, it is preferable that the pushing protrusions 121a and 131a protrude farther than the corresponding surfaces of the electrode pushing block 121 and the surface plate pushing block 131, and the reason for this is that the pushing protrusions 121a and 131a come into first contact with the surface of the shape maintenance member 15 during high-frequency bonding so as to allow melting of the contact areas to proceed preferentially.

The plurality of pushing protrusions 121a and 131a is formed to protrude in directions facing each other in the longitudinal direction of the electrode pushing block 121 and the surface plate pushing block 131, and come into first contact with one surface and the other surface of the shape maintenance member 15 and press the contact areas during high-frequency pressing through the electrode pushing block 121 and the surface plate pushing block 131, thereby allowing the melt of the shape maintenance member 15, the upper part 11a and the lower part 11b melted by heat and pressure applied through high frequency to be pushed and flow into the guide inflow grooves 121b and 131b at the sides of the pushing protrusions 121a and 131a.

The guide inflow grooves 121b and 131b are formed to be recessed into the electrode pushing block 121 and the surface plate pushing block 131 to a designated depth in the longitudinal direction, and guide the melt, which is pressed by the pushing protrusions 121a and 131a and is thus introduced into the guide inflow grooves 121b and 131b, to be injected into the space S formed between the edges of the upper part 11a and the lower part 11b by adhering the sealing tape 14 thereto.

The melt may be injected into the space S through the guide inflow grooves 121b and 131b, because the space S between the edges of the upper part 11a and the lower part 11b is disposed perpendicular to the shape maintenance member 15, when the shape maintenance member 15 at the corner of the air mattress 10 is heated through high frequency, as shown in FIG. 2 (with reference to FIG. (c)).

That is, considering that melting of base materials in contact with each other starts from the inside of the contact area and heads outwards due to characteristics of high frequency, the melt produced by pressing the upper and lower parts 11a and 11b in contact with the surface of the shape maintenance member 15 by the pushing protrusions 121a and 131a protruding in the longitudinal direction of the shape maintenance member 15 flows into the guide inflow grooves 121b and 131b, and then the melt fills the space S having a designated gap, formed because the side surfaces of the upper and lower parts 11a and 11b do not come into surface contact with each other due to the opposite sealing tapes 14, as shown in FIG. 2. In detail, the melt flowing into the guide inflow grooves 121b and 131b flows toward the space S having a relatively low pressure.

Due to such filling of the space S with the melt, the melt fills the space S at the area to which the shape maintenance member 15 is adhered, thereby increasing sealing force at the edges of the upper part 11a and the lower part 11b having relatively reduced adhesive strength.

The pushing protrusions 121a and 131a and the guide inflow grooves 121b and 131b shown in this embodiment may be arranged in various shapes depending on the size of the surfaces of the electrode pushing block 121 and the surface plate pushing block 131, and the number of the pushing protrusions 121a and 131a and the guide inflow grooves 121b and 131b is not limited.

Each of the electrode plate 120 and the surface plate 130 may be provided with a pair of stoppers ST, as shown in FIGS. 5 and 6.

The stoppers ST control the moving distance of the electrode plate 120 that moves for high-frequency pressing so that the electrode plate 120 may be moved by the set distance.

Here, a pair of stoppers ST coupled to both sides of each of the electrode plate 120 and the surface plate 130 in the longitudinal direction is provided, respectively, and the stoppers ST on the electrode plate 120 and the surface plate 130 protrude to be coupled to the electrode plate 120 and the surface plate 130 while maintaining a predetermined length in the opposite directions.

That is, the stoppers ST provided on each of the electrode plate 120 and the surface plate 130 control the electrode plate 120 to be moved by the set distance when the shape maintenance member 15 is adhered to the corner through high frequency, and ensures high-frequency pressing of the shape maintenance member 15 under the best conditions.

In the case that high-frequency heating of the shape maintenance member 15 is performed without applying the stoppers ST, when the electrode plate 120 is moved beyond the set distance, a distance between the electrode pushing block 121 and the surface plate pushing block 131 is too short, and thus, heat is transmitted to the upper part 11a and the lower part 11b in the state in which respective pieces of each of the upper part 11a and the lower part 11b are too close to each other, as shown in an enlarged view of FIG. 2, and thereby, mutual heat fusion occurs between the respective pieces of each of the upper part 11a and the lower part 11b.

In this case, after adhesion of the shape maintenance member 15, the respective pieces of each of the upper part 11a and the lower part 11b may not be separated from each other due to the mutual heat fusion, and thus, the air mattress 10 should be discarded because the shape of the corner of the air mattress 10 may not be formed smoothly.

Therefore, the stoppers ST serve to maintain a gap between the electrode plate 120 and the surface plate 130 at all times so as to achieve stable heat fusion among the shape maintenance member 15, the upper and lower parts 11a and 11b, and the sealing tape 14.

Although this embodiment illustrates a pair of stoppers ST provided on both ends of each of the electrode plate 120 and the surface plate 130 in the longitudinal direction, a pair of stoppers ST may be provided on both ends of any one of the electrode plate 120 and the surface plate 130 in the longitudinal direction, and therefore, the positions of the stoppers ST are not limited.

In addition, a leveling member 135 which maintains leveling of the shape maintenance member 15 surrounding the corner of the air mattress 10 disposed between the electrode plate 120 and the surface plate 130 may be further provided on the upper surface of the surface plate pushing block 131.

The leveling member 135 maintains the shape of a plate having a predetermined area, is fixed in a horizontal state to the upper surface of the surface plate pushing block 131, and may thus horizontally support the upper end of the shape maintenance member 15 disposed between the electrode plate 120 and the surface plate 130 (with reference to FIGS. 7(a) to 7(c) and 8(a) to 8(c)).

Hereinafter, with reference to the accompanying drawings, a process of adhering the shape maintenance member 15 to the corner of the air mattress 10 using the high-frequency welding apparatus 100 will be described as follows.

First, corner portions of two pieces of each of the upper part 11a and the lower part 11b of the air mattress 10, to which the sealing tape 14 is adhered, are adhered to face each other, as shown in FIG. 2.

Further, after locating the longitudinal center of the shape maintenance member 15 at an opening between the corner portions serving as the distal end of a corner of the air mattress 10, both sides of the shape maintenance member 15 are folded and adhered to both side surfaces of the distal end of the corner based on the longitudinal center of the air mattress 10.

The corner of the air mattress 10 provided with the shape maintenance member 15 is placed between the electrode pushing block 121 and the surface plate pushing block 131, as shown in FIGS. 7(a) and 8(a).

Thereafter, the corner of the air mattress 10 is moved upward in the drawings, as shown in FIGS. 7(b) and 8(b), so that leveling of the shape maintenance member 15 is maintained by supporting the bent upper end of the shape maintenance member 15 by the lower surface of the leveling member 135.

At this time, the pushing protrusions 131a of the pushing block 131 are in a state of not pressing the surface of the shape maintenance member 15, and the electrode pushing block 121 has not yet moved due to non-driving of the electrode plate 120.

In the above state, as the electrode plate 120 is moved from right to left in the drawings by driving the movement control device 111, the electrode pushing block 121 is adhered to the right surface of the shape maintenance member 15 in the drawings and presses the shape maintenance member 15, as shown in FIGS. 7(c) and 8(c).

At this time, a high-frequency current is already being applied to the electrode plate 120.

Movement of the electrode plate 120 is performed until the stoppers ST of the electrode plate 120 and the stoppers ST of the surface plate 130 come into contact with each other. That is, the electrode plate 120 is moved only to a distance that allows high-frequency heating of the shape maintenance member 15 to be ideally performed.

At the same time, the electrode pushing block 121 continues to press the shape maintenance member 15 depending on continuous movement of the electrode plate 120, and in this process, the respective pushing protrusions 121a and 131a in first contact with the shape maintenance member 15 primarily press both surfaces of the shape maintenance member 15, and melt the insides between the upper and lower parts 11a and 11b and the sealing tape 14 in contact with the shape maintenance member 15.

At this time, the melt between the upper and lower parts 11a and 11b and the sealing tape 14 in contact with the shape maintenance member 15 melted by pressure applied by the pushing protrusions 121a and 131 flows into the guide inflow grooves 121 and 131b secondarily contacting the shape maintenance member 15 by pressure continuously applied by the electrode pushing block 121.

Further, the melt flowing into the guide inflow grooves 121b and 131b flows along the guide inflow grooves 121b and 131b, and in this process, is injected into the space S between the edges of the upper part 11a and the lower part 11b to fill the space S at the area to which the shape maintenance member 15 is adhered, as indicated by arrows shown in an enlarged view of FIG. 7(c).

Then, the shape maintenance member 15, the upper and lower parts 11a and 11b and the sealing tape 14 formed of the same material are melted and fused together to form a single body, as shown in an enlarged view of FIG. 8(c), thereby being capable of maximizing the sealed state of the corner and fundamentally preventing deterioration of adhesive strength.

In addition, of course, areas where only the shape maintenance member 15 and the upper and lower parts 11a and 11b are in contact with each other are also fused to each other through melting.

Further, the electrode plate 120 continues to be moved until the stoppers ST come into contact with each other, as shown in FIG. 8(c).

When adhesion of the shape maintenance member 15 using the high-frequency welding apparatus 100 is completed, protrusions and depressions are imprinted on the outer surface of the shape maintenance member 15 due to pressing through the pushing protrusions 121a and 131a and the guide inflow grooves 121b and 131b, as shown in FIG. 1.

As described above, the high-frequency welding apparatus according to the present invention may control the position of an area of a corner of an air mattress, to which a shape maintenance member is adhered, leveling of the shape maintenance member, and pressure applied to the shape maintenance member when adhering the shape maintenance member to the corner, thus not requiring dependence on worker's proficiency and enabling the adhesion process of the shape maintenance member to be carried out quickly.

Further, the shape maintenance member is melted using high frequency and is thus fused to the air mattress, thereby being capable of fundamentally preventing deterioration of adhesion between the shape maintenance member and the air mattress over time.

In addition, the shape maintenance member serves as a finishing material of the corner of the air mattress, and at the same time, as the shape maintenance member and the air mattress are fused in an adhesive area therebetween, the shape maintenance member serves as a pillar on the outermost side of each corner, thereby enabling each corner to withstand a set load, and thus exhibiting an excellent structural effect of preventing safety incidents.

Moreover, because the shape maintenance member is heat-welded to the corner of the air mattress using high frequency, an eco-friendly air mattress may be produced without using an adhesive, such as an oil-based adhesive, unlike the conventional methods.

As is apparent from the above description, a high-frequency welding apparatus according to the present invention may control the position of a portion of a corner of an air mattress, to which a shape maintenance member is adhered, leveling of the shape maintenance member, and pressure applied to the shape maintenance member when adhering the shape maintenance member to the corner, thus not requiring dependence on worker's proficiency and enabling the adhesion process of the shape maintenance member to be carried out quickly.

Further, the shape maintenance member is melted using high frequency and is thus fused to the air mattress, thereby being capable of fundamentally preventing deterioration of adhesion between the shape maintenance member and the air mattress over time.

In addition, the shape maintenance member serves as a finishing material of the corner of the air mattress, and at the same time, as the shape maintenance member and the air mattress are fused in an adhesive area therebetween, the shape maintenance member serves as a pillar on the outermost side of each corner, thereby enabling each corner to withstand a set load, and thus exhibiting an excellent structural effect of preventing safety incidents.

Moreover, because the shape maintenance member is heat-welded to the corner of the air mattress using high frequency, an eco-friendly air mattress may be produced without using an adhesive, such as an oil-based adhesive, unlike the conventional methods.

As above, the high-frequency welding apparatus of the present invention has been described with reference to the exemplary embodiments and the accompanying drawings, but this is only intended to help understanding of the invention and is not intended to limit the technical scope of the invention.

That is, although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A high-frequency welding apparatus for bonding a corner of an air mattress configured to adhere a shape maintenance member to each corner of the air mattress in which a sealing tape is adhered to edges of an upper part and a lower part configured to face each other, the high-frequency welding apparatus comprising:
a housing equipped with a high-frequency oscillator installed therein;
an electrode plate disposed at one side of the housing such that a positive power supply is connected to and in the electrode plate, configured to move a horizontal direction so as to press the shape maintenance member configured to surround the corner of the air mattress;
a surface plate disposed to collinearly face the electrode plate with the shape maintenance member interposed therebetween, and configured to support the pressed shape maintenance member; and
an electrode pushing block and a surface plate pushing block formed of a metal and fixed to front ends of the electrode plate and the surface plate, respectively, to apply high-frequency pressure to the shape maintenance member and to guide a melt of the shape maintenance member, the upper part and the lower part to be injected into a space between the edges of the upper part and the lower part adhered to the sealing tape,
wherein a plurality of pushing protrusions and a plurality of guide inflow grooves are alternately formed at corresponding positions on facing surfaces of the electrode pushing block and the surface plate pushing block, the pushing protrusions come into first contact with the shape maintenance member and press contact areas during high-frequency pressing so that the melt of the shape maintenance member, the upper part and the lower part flows into the guide inflow grooves at sides of the pushing protrusions, and the guide inflow grooves guide the melt to be injected into the space formed between the edges of the upper part and the lower part.

2. The high-frequency welding apparatus of claim 1, wherein the pushing protrusions protrude farther than the corresponding surfaces of the electrode pushing block and the surface plate pushing block.

3. The high-frequency welding apparatus of claim 1, wherein a pair of stoppers configured to control a moving distance of the electrode plate protrudes from both sides of the electrode plate and the surface plate or both sides of any one of the electrode plate and the surface plate.

4. The high-frequency welding apparatus of claim 1, wherein a leveling member configured to maintain leveling of the shape maintenance member configured to surround the corner of the air mattress disposed between the electrode plate and the surface plate is further provided on an upper surface of the surface plate pushing block.

5. The high-frequency welding apparatus of claim 1, wherein a movement control device provided such that the electrode plate is installed thereon to be movable and configured to control a moving distance of the electrode plate is provided between the electrode plate and the housing.

6. The high-frequency welding apparatus of claim 1, wherein a current amount control knob configured to control an amount of current applied to the electrode plate is provided on the housing.
